(19) United States
(12) Patent Application Publication
(10) Pub. No.: US 2010/0160841 A1
(43) Pub. Date: Jun. 24, 2010

(54) Massaging Device That Is Assembled and Disassembled Easily and Quickly

(76) Inventor: Dong-Her Wu, Pu Yen Hsiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/343,812

(22) Filed: Dec. 24, 2008

(51) Int. Cl. A61H 7/00; A61H 15/00

(52) U.S. Cl. 601/135; 601/134; 601/112

(57) ABSTRACT

A massaging device includes a support base, a drive member rotatably mounted on the support base, a rotation disk rotatable relative to the support base and provided with a driven member which is detachably mounted on and rotated by the drive member to drive the rotation disk to rotate relative to the support base, and a massaging head mounted on the rotation disk to rotate in concert with the rotation disk and rotatable relative to the rotation disk. Thus, the massaging head is directly attached to the rotation disk, and the rotation disk is directly attached to the support base without needing aid of any hand tool.

### BACKGROUND OF THE INVENTION

1. Field of the Invention

The present invention relates to a massaging device and, more particularly, to a portable massaging device whose massaging head is operated in an eccentrically revolving manner.

2. Description of the Related Art

A conventional massaging device in accordance with the prior art shown in FIGS. 13 and 14 comprises a support base 60, a drive member 61 rotatably mounted on the support base 60, a substantially Z-shaped crank 70 having a first end provided with an input rod 72 secured on and rotated by the drive member 61 and a second end provided with an output rod 73 which is parallel with the input rod 72 and is provided with a screw bore 71, a massaging head 90 mounted on the output rod 73 of the crank 70 to rotate with the output rod 73 of the crank 70 and having a central portion provided with a stepped through hole 93, a bearing 80 mounted between the output rod 73 of the crank 70 and the massaging head 90, and a locking screw 94 extending through the through hole 93 of the massaging head 90 and screwed into the screw bore 71 of the output rod 73 of the crank 70. The support base 60 has an inner portion provided with a drive motor (not shown) connected with the drive member 61 to drive and rotate the drive member 61. The massaging head 90 has a bottom provided with a recessed receiving seat 92 abutting the output rod 73 of the crank 70 and a top provided with a plurality of massaging bosses 91. The bearing 80 is mounted on the output rod 73 of the crank 70 and received in the receiving seat 92 of the massaging head 90.

In operation, when the drive member 61 is rotated by the drive motor of the support base 60, the input rod 72 of the crank 70 is rotated by the drive member 61 to rotate the output rod 73 of the crank 70 eccentrically so that the massaging head 90 is rotated and moved by the output rod 73 of the crank 70 to provide a massaging effect to a user's body.

However, the massaging head 90 is mounted on the output rod 73 of the crank 70 by the locking screw 94, so that a user needs to use a hand tool to screw the locking screw 94 so as to mount the massaging head 90 on the output rod 73 of the crank 70 and to unscrew the locking screw 94 so as to remove the massaging head 90 from the output rod 73 of the crank 70, thereby causing inconvenience to the user. In addition, the tightening direction of the locking screw 94 is the same as the rotation direction of the massaging head 90, so that the locking screw 94 is easily screwed and tightened to an excessive extent during rotation of the massaging head 90, thereby causing difficulty to the user when the user wishes to unscrew the locking screw 94.

### BRIEF SUMMARY OF THE INVENTION

In accordance with the present invention, there is provided a massaging device, comprising a support base, a drive member rotatably mounted on the support base, a rotation disk rotatable relative to the support base and provided with a driven member which is detachably mounted on and rotated by the drive member to drive the rotation disk to rotate relative to the support base, and a massaging head mounted on the rotation disk to rotate in concert with the rotation disk and rotatable relative to the rotation disk.

The primary objective of the present invention is to provide a massaging device that is assembled and disassembled easily and quickly.

Another objective of the present invention is to provide a massaging device, wherein the retaining section of the second mounting ring is snapped onto the retaining portion of the first mounting ring to mount the second mounting ring of the massaging head onto of the first mounting ring of the rotation disk and to attach the massaging head to the rotation disk, while the locking hook of the driven member is locked onto the respective locking protrusion of the drive member to detachably lock the driven member onto the drive member and to attach the rotation disk to the support base, so that the massaging head is directly attached to the rotation disk, and the rotation disk is directly attached to the support base without needing aid of any hand tool, thereby facilitating a user assembling and disassembling the massaging device.

A further objective of the present invention is to provide a massaging device, wherein the user only needs to pull the rotation disk outwardly relative to the support base for replacement of the massaging head, thereby greatly facilitating the user replacing the massaging head 30.

A further objective of the present invention is to provide a massaging device, wherein the reaction of the eccentric rotation of the rotation disk and the massaging head is counteracted by rotation of the massaging head relative to the rotation disk, so that the massaging head is moved relative to the support base eccentrically and is moved on the user's body slowly and smoothly in a reciprocal manner to provide a softly massaging effect to the user's body and to provide a comfortable sensation to the user.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a massaging device in accordance with the preferred embodiment of the present invention.

FIG. 2 is an exploded perspective view of the massaging device as shown in FIG. 1.

FIG. 3 is a side cross-sectional view of the massaging device as shown in FIG. 1.

FIG. 4 is a side cross-sectional operational view of the massaging device as shown in FIG. 1.

FIG. 5 is a front operational view of the massaging device as shown in FIG. 1.

FIG. 6 is a partially exploded perspective view of a massaging device in accordance with another preferred embodiment of the present invention.

FIG. 7 is a side cross-sectional assembly operational view of the massaging device as shown in FIG. 6.

FIG. 8 is a side cross-sectional assembly operational view of the massaging device as shown in FIG. 6.

FIG. 9 is an exploded perspective view of a massaging device in accordance with another preferred embodiment of the present invention.

FIG. 10 is a side cross-sectional assembly view of the massaging device as shown in FIG. 9.

FIG. 11 is an exploded perspective view of a massaging device in accordance with another preferred embodiment of the present invention.

FIG. 12 is a side cross-sectional assembly view of the massaging device as shown in FIG. 11.

FIG. 13 is an exploded perspective view of a conventional massaging device in accordance with the prior art.

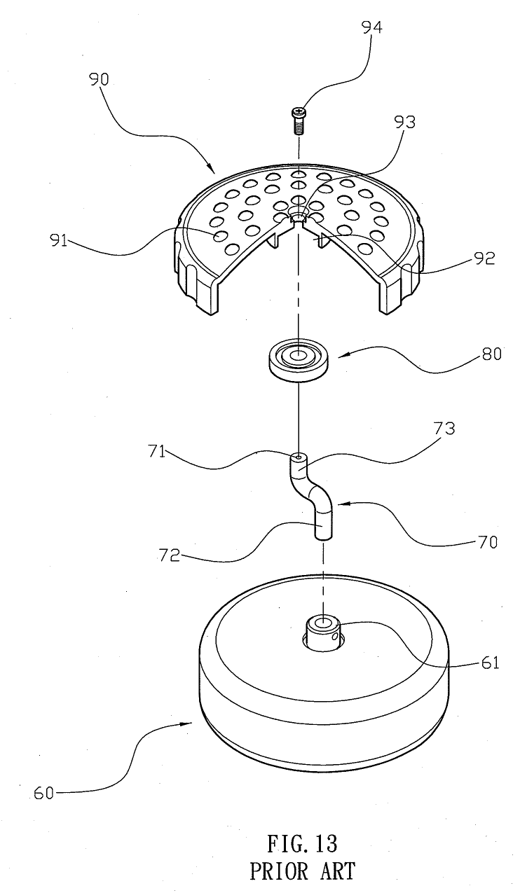

FIG. 14 is a side cross-sectional assembly view of the conventional massaging device as shown in FIG. 13.

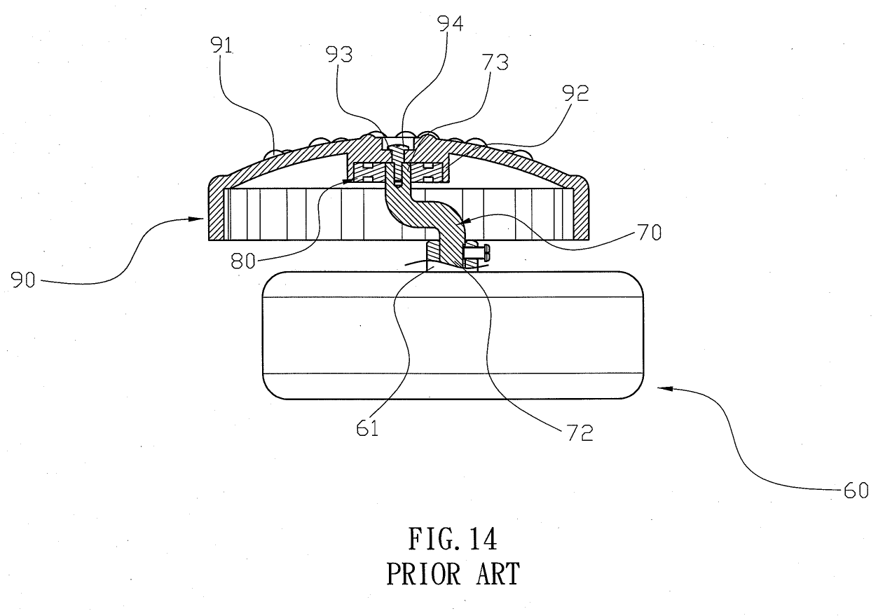

### DETAILED DESCRIPTION OF THE INVENTION

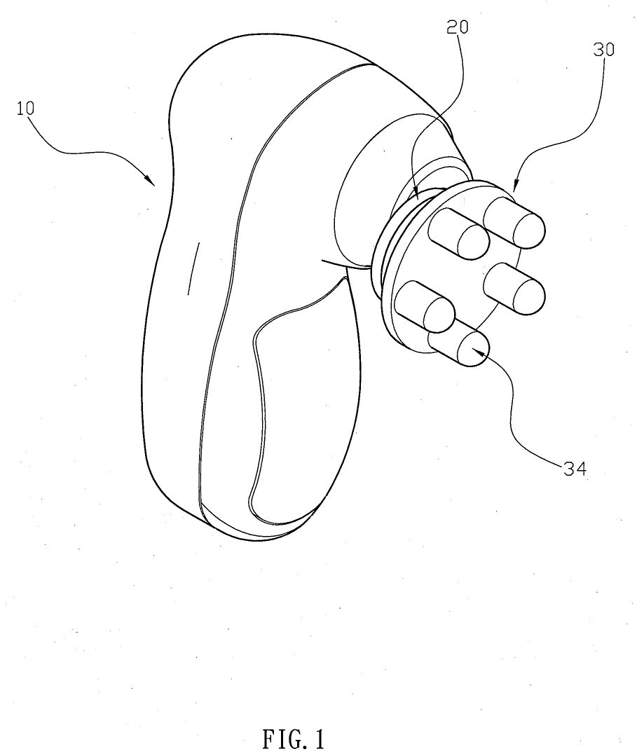

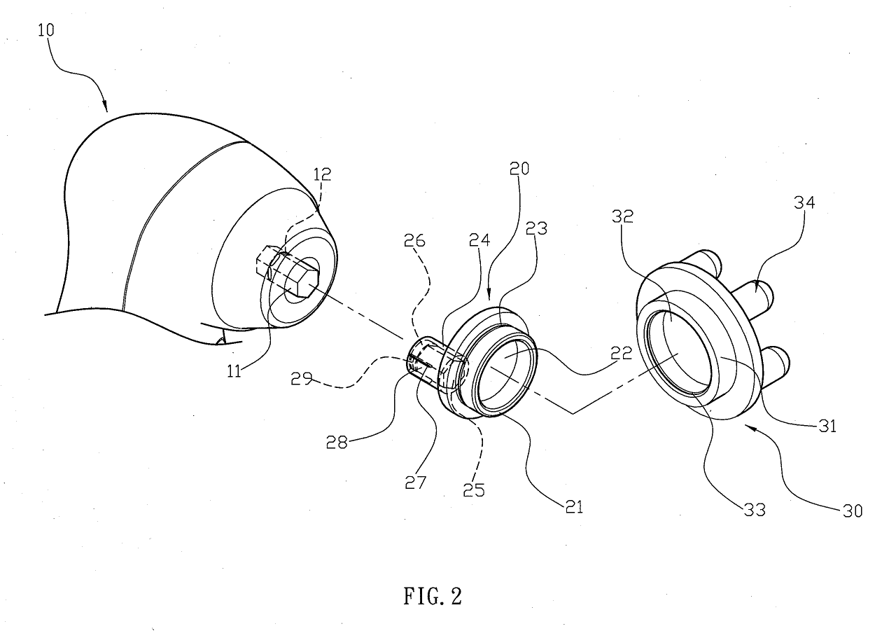

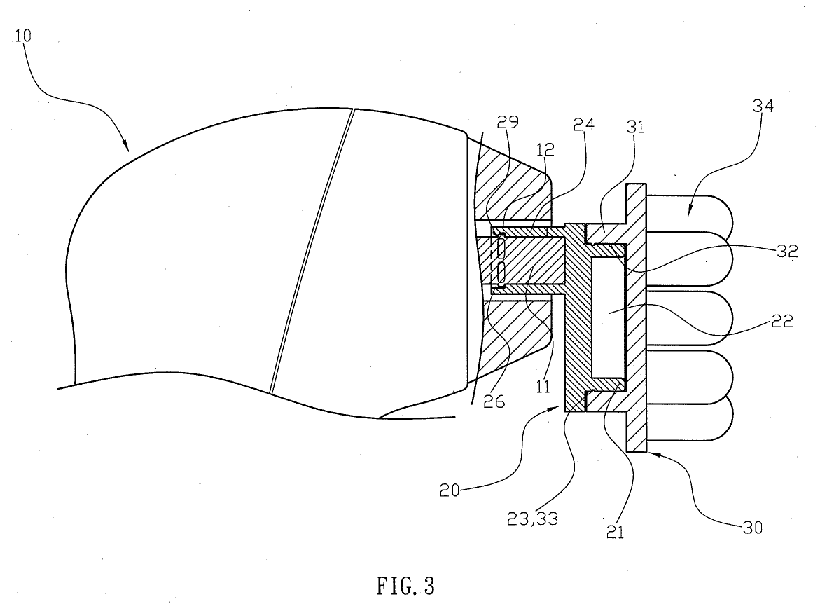

Referring to the drawings and initially to FIGS. 1-5, a massaging device in accordance with the preferred embodiment of the present invention comprises a support base 10, a drive member 11 rotatably mounted on the support base 10, a rotation disk 20 rotatable relative to the support base 10 and provided with a driven member 24 which is detachably mounted on and rotated by the drive member 11 to drive the rotation disk 20 to rotate relative to the support base 10, and a massaging head 30 mounted on the rotation disk 20 to rotate in concert with the rotation disk 20 and rotatable relative to the rotation disk 20.

The support base 10 has an inner portion provided with a drive motor (not shown) connected with the drive member 11 to drive and rotate the drive member 11.

The drive member 11 has a periphery provided with a plurality of locking protrusions 12. Each of the locking protrusions 12 of the drive member 11 is perpendicular to a longitudinal direction of the drive member 11. The drive member 11 has a polygonal shape and has multiple faces. Each of the locking protrusions 12 of the drive member 11 is formed on a respective one of the multiple faces of the drive member 11.

The driven member 24 is integrally formed on a first side of the rotation disk 20 and is located at an eccentric position deviated from a central portion of the rotation disk 20. The driven member 24 has an inner wall provided with a polygonal mounting hole 25 mounted on the drive member 11 so that the driven member 24 is rotated by the drive member 11, and the rotation disk 20 is driven by the driven member 24, to rotate and move relative to the support base 10 eccentrically. The mounting hole 25 of the driven member 24 has an end portion provided with a passage 26 which has a dimension greater than that of the mounting hole 25 to provide an evading space to allow passage of the locking protrusions 12 of the drive member 11.

The mounting hole 25 of the driven member 24 has a peripheral wall provided with at least one locking hook 29 detachably locked onto one of the locking protrusions 12 of the drive member 11 to detachably lock the driven member 24 onto the drive member 11. The locking hook 29 of the driven member 24 is located in the passage 26 and is perpendicular to a longitudinal direction of the driven member 24. The driven member 24 has a peripheral wall provided with two elongate slits 27 to define two elastic pieces 28 so that the driven member 24 is made flexible by provision of the two elastic pieces 28. Each of the elongate slits 27 of the driven member 24 is parallel with a longitudinal direction of the driven member 24 and extends from an end face to a middle position of the driven member 24. The locking hook 29 of the driven member 24 is formed on one or each of the two elastic pieces 28.

The rotation disk 20 has a second side provided with a first mounting ring 21. The first mounting ring 21 of the rotation disk 20 has an inner wall provided with a receiving space 22 and an outer wall provided with a retaining portion 23. Preferably, the retaining portion 23 of the first mounting ring 21 is an annular retaining groove.

The massaging head 30 and the rotation disk 20 are driven by the driven member 24 to rotate and move relative to the support base 10 eccentrically. The massaging head 30 has a first side provided with a second mounting ring 31 rotatably mounted on the first mounting ring 21 of the rotation disk 20 and a second side provided with a massaging mechanism 34 to provide a massaging effect to a user. The second mounting ring 31 of the massaging head 30 has an inner wall provided with a mounting space 32 rotatably mounted on the first mounting ring 21 of the rotation disk 20. The mounting space 32 of the second mounting ring 31 has a peripheral wall provided with a retaining section 33 locked onto the retaining portion 23 of the first mounting ring 21. Preferably, the retaining section 33 of the second mounting ring 31 is an annular retaining rib.

In assembly, the retaining section 33 of the second mounting ring 31 is snapped onto the retaining portion 23 of the first mounting ring 21 to mount the second mounting ring 31 of the massaging head 30 onto of the first mounting ring 21 of the rotation disk 20 and to attach the massaging head 30 to the rotation disk 20. Then, the mounting hole 25 of the driven member 24 is mounted on the drive member 11. Thus, when the locking hook 29 of the driven member 24 is moved to abut the respective one of the locking protrusions 12 of the drive member 11, the driven member 24 is pressed by the respective one of the locking protrusions 12 of the drive member 11 and is expanded outwardly by the elastic action of the two elastic pieces 28 to allow the locking hook 29 of the driven member 24 to pass by the respective one of the locking protrusions 12 of the drive member 11. After the locking hook 29 of the driven member 24 passes by the respective one of the locking protrusions 12 of the drive member 11, the driven member 24 is contracted inwardly by the elastic action of the two elastic pieces 28 so that the locking hook 29 of the driven member 24 is locked onto the respective one of the locking protrusions 12 of the drive member 11 to detachably lock the driven member 24 onto the drive member 11 and to attach the rotation disk 20 to the support base 10. At this time, the passage 26 of the driven member 24 allow passage of the other locking protrusions 12 of the drive member 11 to prevent the other locking protrusions 12 of the drive member 11 from interfering with assembly of the driven member 24.

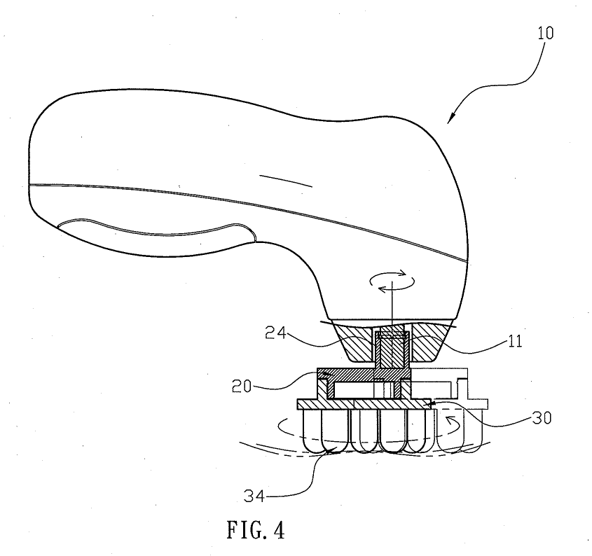

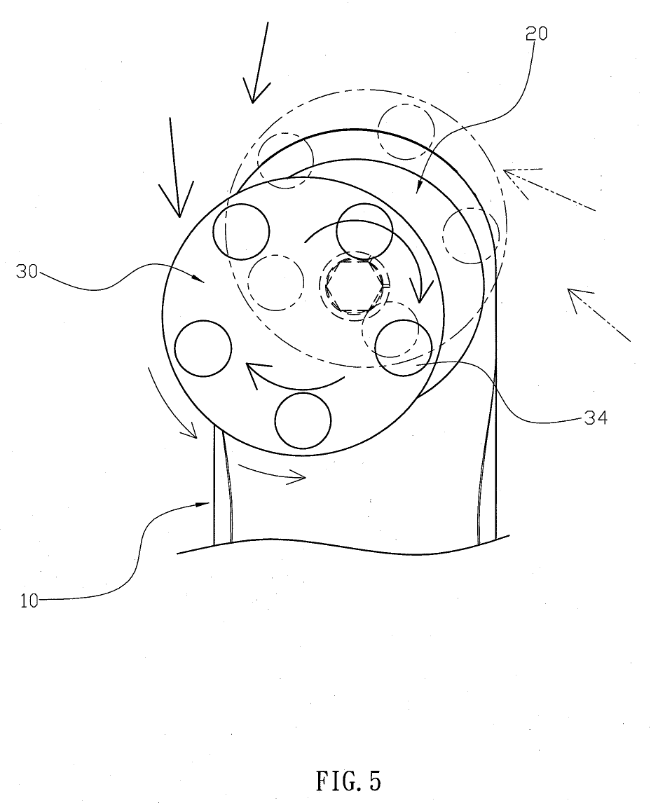

In operation, referring to FIGS. 4 and 5 with reference to FIGS. 1-3, when the drive member 11 is rotated by the drive motor of the support base 10, the driven member 24 is rotated by the drive member 11, so that the massaging head 30 and the rotation disk 20 are driven by the driven member 24 to rotate and move relative to the support base 10 eccentrically. At this time, the massaging mechanism 34 of the massaging head 30 touches and presses the user's body to force the massaging head 30 to rotate relative to the rotation disk 20. In such a manner, the reaction applied by the user's body on the massaging mechanism 34 of the massaging head 30 is counteracted by rotation of the massaging head 30 relative to the rotation disk 20, so that the massaging head 30 is moved relative to the support base 10 eccentrically and is moved on the user's body slowly and smoothly in a reciprocal manner to provide a softly massaging effect to the user's body and to provide a comfortable sensation to the user.

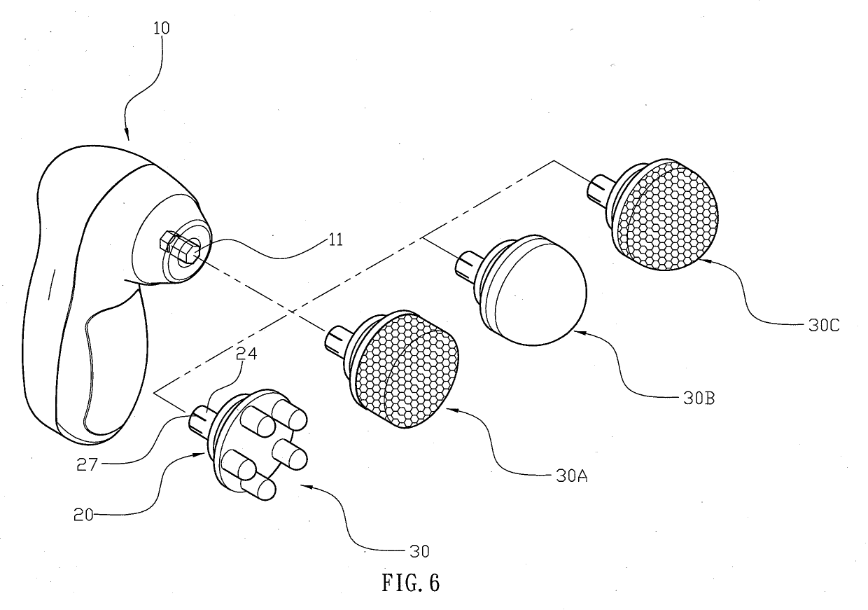

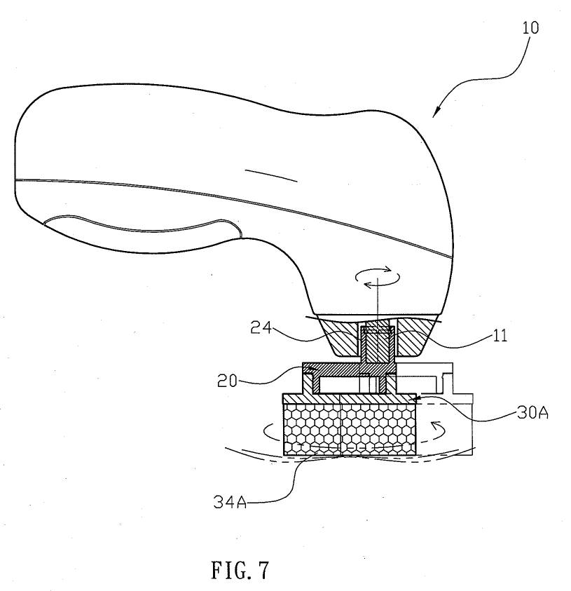

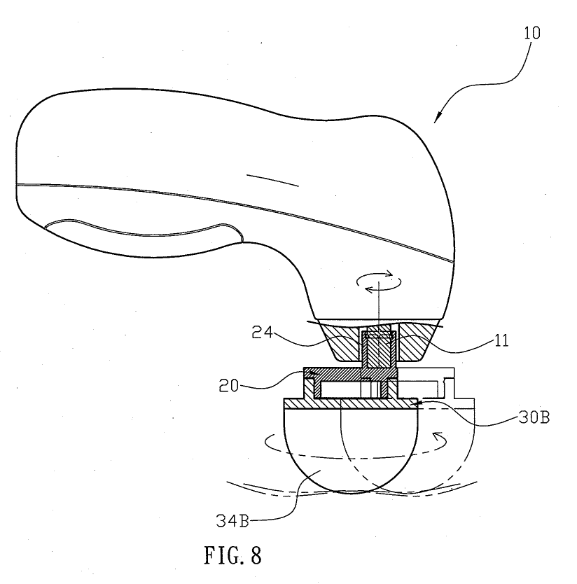

Referring to FIGS. 6-8, the massaging device comprises multiple massaging heads 30, 30A, 30B and 30C of different shapes and types to enhance the versatility of the massaging device.

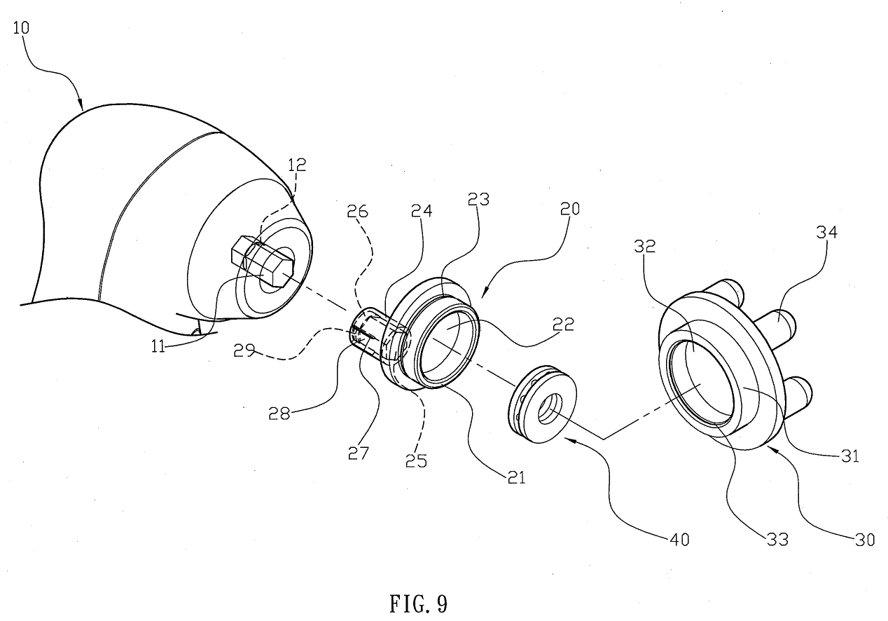

Referring to FIG. 9, the massaging device further comprises a bearing 40 mounted between the first mounting ring 21 of the rotation disk 20 and the second mounting ring 31 of the massaging head 30 to facilitate rotation of the massaging head 30 relative to the rotation disk 20. The bearing 40 is received in the receiving space 22 of the rotation disk 20 and encompassed by the first mounting ring 21 of the rotation disk 20.

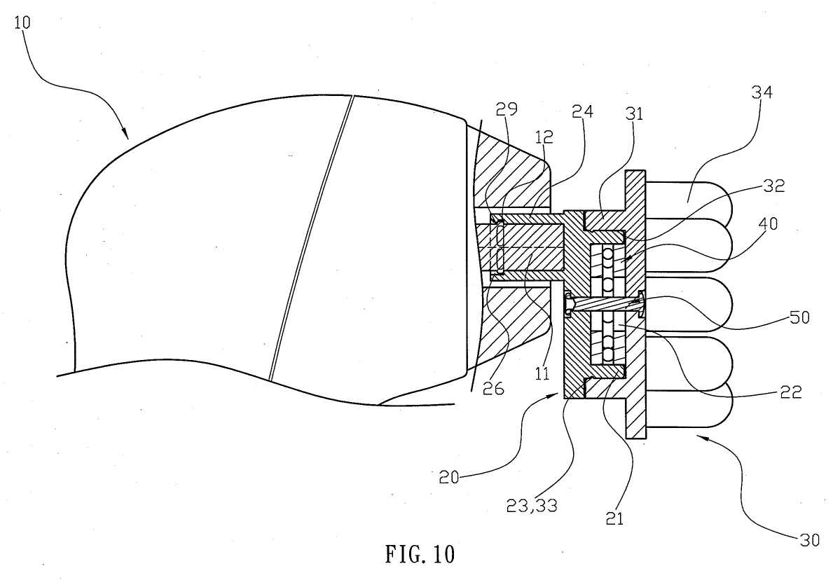

Referring to FIG. 10, the massaging device further comprises a rivet extending through the rotation disk 20 and the massaging head 30 to function as a pivot shaft of the rotation disk 20 and the massaging head 30 and to facilitate rotation of the massaging head 30 relative to the rotation disk 20.

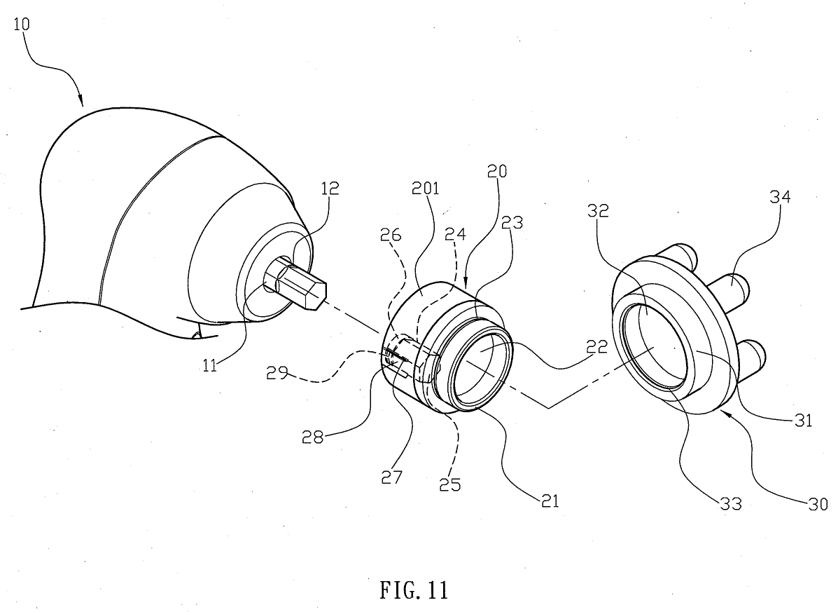

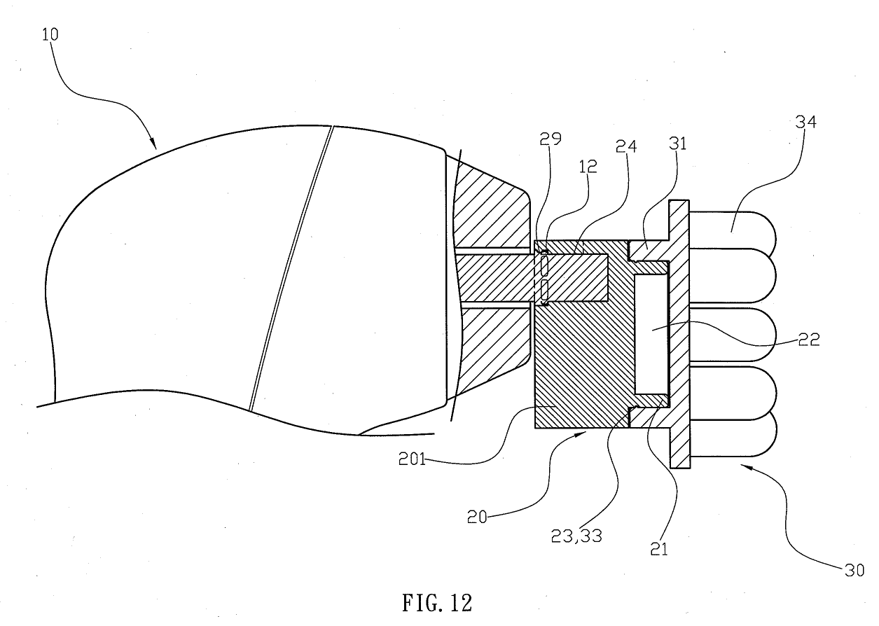

Referring to FIGS. 11 and 12, the first side of the rotation disk 20 is provided with an extension enclosure 201 encompassing the driven member 24 so that the driven member 24 is fully hidden in the extension enclosure 201. Each of the elongate slits 27 of the driven member 24 extends along a peripheral wall of the extension enclosure 201.

Accordingly, the retaining section 33 of the second mounting ring 31 is snapped onto the retaining portion 23 of the first mounting ring 21 to mount the second mounting ring 31 of the massaging head 30 onto of the first mounting ring 21 of the rotation disk 20 and to attach the massaging head 30 to the rotation disk 20, while the locking hook 29 of the driven member 24 is locked onto the respective locking protrusion 12 of the drive member 11 to detachably lock the driven member 24 onto the drive member 11 and to attach the rotation disk 20 to the support base 10, so that the massaging head 30 is directly attached to the rotation disk 20, and the rotation disk 20 is directly attached to the support base 10 without needing aid of any hand tool, thereby facilitating a user assembling and disassembling the massaging device. In addition, the user only needs to-pull the rotation disk 20 outwardly relative to the support base 10 for replacement of the massaging head 30, thereby greatly facilitating the user replacing the massaging head 30. Further, the reaction of the eccentric rotation of the rotation disk 20 and the massaging head 30 is counteracted by rotation of the massaging head 30 relative to the rotation disk 20, so that the massaging head 30 is moved relative to the support base 10 eccentrically and is moved on the user's body slowly and smoothly in a reciprocal manner to provide a softly massaging effect to the user's body and to provide a comfortable sensation to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A massaging device, comprising:
a support base;
a drive member rotatably mounted on the support base;
a rotation disk rotatable relative to the support base and provided with a driven member which is detachably mounted on and rotated by the drive member to drive the rotation disk to rotate relative to the support base;
a massaging head mounted on the rotation disk to rotate in concert with the rotation disk and rotatable relative to the rotation disk.

2. The massaging device of claim 1, wherein
the drive member has a polygonal shape;
the driven member has an inner wall provided with a polygonal mounting hole mounted on the drive member so that the driven member is rotated by the drive member;
the rotation disk is driven by the driven member to rotate and move relative to the support base eccentrically.

3. The massaging device of claim 2, wherein the drive member has a periphery provided with a plurality of locking protrusions;
the mounting hole of the driven member has a peripheral wall provided with at least one locking hook detachably locked onto one of the locking protrusions of the drive member to detachably lock the driven member onto the drive member.

4. The massaging device of claim 3, wherein the mounting hole of the driven member has an end portion provided with a passage which has a dimension greater than that of the mounting hole to provide an evading space to allow passage of the locking protrusions of the drive member.

5. The massaging device of claim 4, wherein
the driven member has a peripheral wall provided with two elongate slits to define two elastic pieces;
the driven member is made flexible by provision of the two elastic pieces.

6. The massaging device of claim 1, wherein
the driven member is integrally formed on a first side of the rotation disk and is located at an eccentric position deviated from a central portion of the rotation disk;
the rotation disk has a second side provided with a first mounting ring;
the massaging head has a first side provided with a second mounting ring rotatably mounted on the first mounting ring of the rotation disk.

7. The massaging device of claim 6, wherein the massaging head has a second side provided with a massaging mechanism.

8. The massaging device of claim 6, wherein the second mounting ring of the massaging head has an inner wall provided with a mounting space rotatably mounted on the first mounting ring of the rotation disk.

9. The massaging device of claim 8, wherein
the first mounting ring of the rotation disk has an outer wall provided with a retaining portion;
the mounting space of the second mounting ring has a peripheral wall provided with a retaining section locked onto the retaining portion of the first mounting ring.

10. The massaging device of claim 6, further comprising:
a bearing mounted between the first mounting ring of the rotation disk and the second mounting ring of the massaging head to facilitate rotation of the massaging head relative to the rotation disk.

11. The massaging device of claim 10, wherein
the first mounting ring of the rotation disk has an inner wall provided with a receiving space;
the bearing is received in the receiving space of the rotation disk and encompassed by the first mounting ring of the rotation disk.

12. The massaging device of claim 10, further comprising:
a rivet extending through the rotation disk and the massaging head to function as a pivot shaft of the rotation disk and the massaging head and to facilitate rotation of the massaging head relative to the rotation disk.

13. The massaging device of claim 6, wherein
the first side of the rotation disk is provided with an extension enclosure encompassing the driven member;
the driven member is fully hidden in the extension enclosure.

14. The massaging device of claim 13, wherein
the driven member has a peripheral wall provided with two elongate slits to define two elastic pieces;
the driven member is made flexible by provision of the two elastic pieces;
each of the elongate slits of the driven member extends along a peripheral wall of the extension enclosure.

15. The massaging device of claim 4, wherein the locking hook of the driven member is located in the passage.

16. The massaging device of claim 9, wherein
the retaining portion of the first mounting ring is an annular retaining groove;
the retaining section of the second mounting ring is an annular retaining rib.

17. The massaging device of claim 5, wherein the locking hook of the driven member is formed on at least one of the two elastic pieces.

18. The massaging device of claim 3, wherein
the drive member has multiple faces.
each of the locking protrusions of the drive member is formed on a respective one of the multiple faces of the drive member.

19. The massaging device of claim 2, wherein the massaging head and the rotation disk are driven by the driven member to rotate and move relative to the support base eccentrically.

20. The massaging device of claim 5, wherein
the locking hook of the driven member is perpendicular to a longitudinal direction of the driven member;
each of the locking protrusions of the drive member is perpendicular to a longitudinal direction of the drive member;
each of the elongate slits of the driven member is parallel with a longitudinal direction of the driven member and extends from an end face to a middle position of the driven member.
